(19) United States
(12) Patent Application Publication
(10) Pub. No.: US 2025/0303863 A1
(43) Pub. Date: Oct. 2, 2025

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventor: Sayaka TSUBOTA, Nagoya-shi (JP)

(73) Assignee: TOYOTA JIDOSHA KABUSHIKI KAISHA, Toyota-shi (JP)

(21) Appl. No.: 19/077,150

(22) Filed: Mar. 12, 2025

(30) Foreign Application Priority Data
Apr. 2, 2024 (JP) 2024-059584

(51) Int. Cl. B60K 35/28

(52) U.S. Cl. CPC B60K 35/28; B60K 2360/119; B60K 2360/589; B60K 2360/592

(57) ABSTRACT

The information processing apparatus displays, based on the travelling history of one or more vehicles, a plurality of icons indicating the locations of each vehicle at a plurality of times within a first area set on a map. When any one of the plurality of icons is selected, the information processing apparatus transmits, to the corresponding vehicle, a video request for requesting transmission of the video photographed at the corresponding time.

### CROSS REFERENCE TO THE RELATED APPLICATION

This application claims the benefit of Japanese Patent Application No. 2024-59584, filed on Apr. 2, 2024, which is hereby incorporated by reference herein in its entirety.

### BACKGROUND

### Technical Field

The present disclosure relates to a monitoring system.

### Description of the Related Art

There is known a technology for monitoring incidents, accidents, and etc. using a moving object equipped with a camera. For example, Patent Literature 1 discloses a system that uses a server apparatus to manage the history of vehicle driving positions and identifies vehicles equipped with drive recorders that are located in the vicinity of an informant.

### CITATION LIST

### Patent Literature

Patent Literature 1: Japanese Patent Application Laid-Open No. 2023-019792

### SUMMARY

An object of the present disclosure is to provide a technique that can improve the convenience of a monitoring system using a vehicle.

One aspect of the present disclosure is an information processing apparatus comprising a controller configured to execute processing of:
displaying, within a first area set on a map, a plurality of icons indicating the locations of each vehicle at a plurality of times based on the travelling history of the one or more vehicles; and
transmitting, when any one of the plurality of icons is selected, to the corresponding vehicle a video request for requesting transmission of a video captured at the corresponding time.

One aspect of the present disclosure is an information processing method may be comprising following processing performed by a computer:
displaying, within a first area set on a map, a plurality of icons indicating the locations of each vehicle at a plurality of times based on the travelling history of the one or more vehicles; and
transmitting, when any one of the plurality of icons is selected, to the corresponding vehicle a video request for requesting transmission of a video captured at the corresponding time.

Further, another aspect of the present disclosure may be a program for causing a computer to execute the above-described information processing method, or a computer-readable storage medium non-temporarily storing the program.

According to the present disclosure, it is possible to improve the convenience of a monitoring system using a vehicle.

### BRIEF DESCRIPTION OF THE DRAWINGS

FIG. 1 is a diagram illustrating an overview of a monitoring system according to a first embodiment.

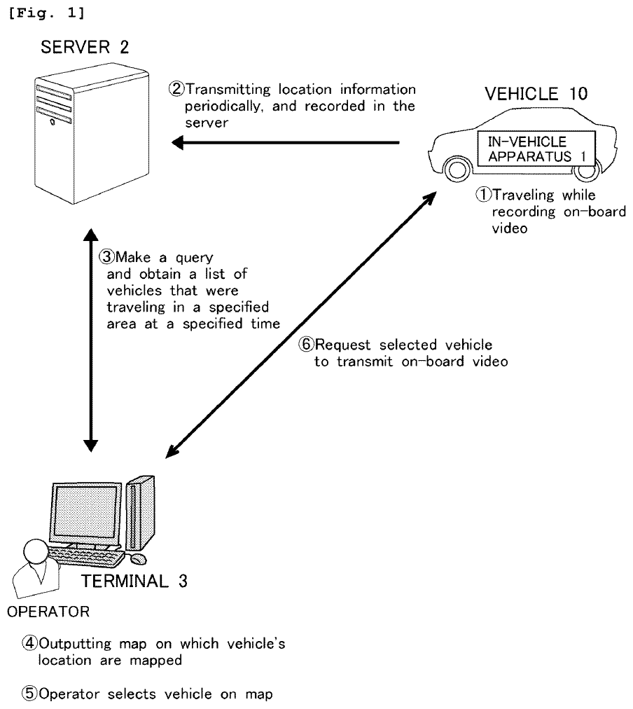

FIG. 2 is a diagram illustrating an example configuration of each component included in the monitoring system according to the first embodiment.

FIG. 3 is diagram illustrating an example of vehicle data, a vehicle data table, and a vehicle list.

FIG. 4 is a diagram illustrating an example of a screen displayed on a terminal in the first embodiment.

FIG. 5 is a sequence diagram illustrating an example of a process in which a server collects vehicle data and provides a vehicle list.

FIG. 6 is a sequence diagram illustrating an example of a process for playing back an on-board video.

### DESCRIPTION OF THE EMBODIMENTS

In recent years, automobiles have become increasingly connected. Accordingly, an increasing number of vehicles are equipped with communication functions. In addition, the number of vehicles equipped with dashboard camera is increasing.

In relation to this, efforts are being made to make on-board video captured by dashboard camera (e.g., drive recorder) available for inquiry by a predetermined agency, thereby making it useful for initial responses to incidents and accidents. For example, if a predetermined agency receives an emergency report regarding an event such as an incident or an accident etc., the predetermined agency can quickly confirm the circumstances of scene by obtaining on-board video from a vehicle that has travelled near scene around the time the event occurred. As a system for this purpose, a system is known in which icons or the like representing the traveling locations of a plurality of vehicles at a given time in the past are mapped on a map and presented the map to an operator of the predetermined agency.

The system obtains location information of vehicles that were traveling in a specified area around the time specified by the operator (for example, five minutes before the time of report) and maps this on map. The operator selects, on map, a vehicle that has travelled near a desired location (e.g., the location where the report was made) at any time close to the desired time (e.g., report time). The system also requests the vehicle to transmit the on-board video captured at the desired time. This allows the operator to view on-board video that may capture the scene of the report.

However, as the number of vehicles capable of providing on-board video increases, a myriad of icons will be displayed on the screen, particularly in urban areas. As a result, problems may arise such as a degradation of the user experience, such as the operator having difficulty seeing the map in the background. Furthermore, there is a risk that computer resources resources related (particularly to graphics) will be wasted unnecessarily. In addition, mapping over a wide area could lead to inferences such as “a particular vehicle always being present in the same location,” which could raise privacy concerns. The information processing apparatus according to the present disclosure solves such a problem.

An information processing device according to one aspect of the present disclosure comprises a controller configured to execute processing of displaying, within a first area set on a map, a plurality of icons indicating the locations of each vehicle at a plurality of times based on the travelling history of the one or more vehicles, and processing of transmitting, when any one of the plurality of icons is selected, to the corresponding vehicle a video request for requesting transmission of a video captured at the corresponding time.

In one example, the controller outputs information for mapping, on a map, icons indicating location of vehicles that have traveled within a predetermined area within a predetermined time period, based on travelling histories of vehicles. The operator can specify a desired vehicle by specifying an icon on a map that is mapped based on the location information. In addition, in response to an operation by the operator, a request can be made to the specified vehicle to provide an image.

However, in such a configuration, all icons included in the display range of the map are displayed. For example, when the scale of a map is reduced, icons are mapped over a wide area, which can cause problems such as making it difficult for the operator to see the screen and reducing the drawing speed.

Therefore, in the information processing apparatus according to the present disclosure, the controller displays a plurality of icons indicating the locations of the vehicles within a first area set on the map. The first area may be automatically set to include a predetermined location on the map. For example, the controller may draw a figure such as “a circle with a radius of 100 meters centered at the center point of the map” and set the inside of the figure as the first area. The center and the radius of the first area may be selectable by an operator. For example, when the operator specifies a point on a map, a first area may be drawn with the specified point as its center. Also, when the operator moves the display area of the map or changes the scale, the first area may be automatically drawn. The icon may not have to be displayed in any area other than the first area.

Alternatively, when the operator specifies a point on the map, the controller may set the first area including the specified point. In this case, the controller may display, within the first area, icons corresponding to vehicles that have traveled within the first area.

That is, the setting of the first area and the drawing of the icon may be started when a point is specified by the operator. According to this configuration, data acquisition can start after the first area is set at a location desired by the operator, so that the amount of data transfer and the amount of processing by the processor can be kept to a minimum.

Hereinafter, specific embodiments of the present disclosure will be described with reference to the drawings. Unless otherwise specified, the hardware configuration, module configuration, functional configuration, and the like described in each embodiment are not intended to limit the technical scope of the present disclosure to only those.

### FIRST EMBODIMENT

### Overview of System

### System Overview

An overview of the monitoring system according to the first embodiment will be described with reference to FIG. The monitoring system according to this embodiment includes a plurality of vehicles 10, a server 2, a terminal 3. The vehicle 10 is a connected vehicle that can access a wireless communication network. The vehicle 10 is configured to be able to communicate with the server 2 via a wireless communication network (e.g., a cellular communication network).

The vehicle 10 is equipped with an in-vehicle apparatus 1. The in-vehicle apparatus 1 functions as a drive recorder and a wireless communication device. The in-vehicle apparatus 1 has a function of obtaining moving images (hereinafter referred to as “on-board videos”) of the area in front of the vehicle using an dashboard camera, a function of storing the obtained on-board videos, and a function of providing the stored on-board videos to an external device (e.g., server 2) in response to a request from the external device. In addition, the vehicle 10 has a function of periodically transmitting location information to the server 2.

In this embodiment, in-vehicle apparatus 1 has a wireless communication function, but the vehicle 10 may also have a data communication module (hereinafter referred to as DCM) for connecting the components of the vehicle 10 to communication network. That is, the in-vehicle apparatus and the wireless communication device may be separate.

The server 2 is configured to be able to communicate with a plurality of vehicles 10 via a communication network. The server 2 periodically acquires location information from a plurality of vehicles 10 under the control of the monitoring system, and stores the acquired location information in a database. By referring to the above database, it is possible to identify locations and times where multiple vehicles 10 under the control of the system have traveled in the past.

Based on the information acquired from the server 2, the terminal 3 identifies the vehicle 10 which is estimated to have the desired on-board video. The terminal 3 obtains the on-board video from the identified vehicle 10. Specifically, the terminal 3 makes an inquiry to the server 2 and obtains a list of vehicles 10 that have been traveling within a specified area at a specified time (vehicle list). The terminal 3 maps the corresponding vehicles on a map and accepts the selection of the vehicle from the operator. The terminal 3 also requests the selected vehicle 10 to transmit on-board video. This allows the operator of the terminal 3 to check the on-board video captured by the selected vehicle.

The terminal 3 is installed in an agency that uses the on-board video captured by the vehicle 10. Examples of such agencies include a police agency and a fire agency. For example, when a fire agency uses the terminal 3, an emergency report is used as a trigger for the operator to identify a vehicle 10 which was traveling near the scene of the report around the report time, and acquiring on-board video from the vehicle 10.

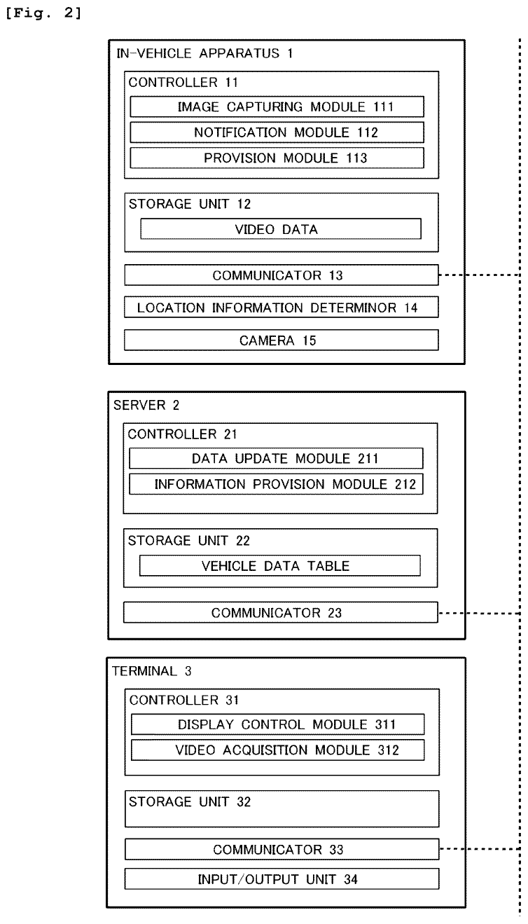

Next, the hardware and software configurations of the devices constituting the monitoring system will be described. FIG. 2 is a diagram illustrating a schematic configuration of in-vehicle 10 apparatus 1 mounted on a vehicle, server 2, and terminal 3 operated by an operator.

The in-vehicle apparatus 1 can be configured as a computer having a processor (CPU, GPU, etc.), a main memory (RAM, ROM, etc.), and an auxiliary memory (EPROM, hard disk drive, removable media, etc.). The auxiliary memory stores an operating system (OS), various programs, various tables, and the like.

By the processor executing the program stored in the auxiliary memory, functions various that meet specific purposes, as described below, can be realized. Note that, some or all of the functions may be realized as a hardware module using hardware circuits such as ASICs and FPGAs.

The in-vehicle apparatus 1 includes a controller 11, a storage unit 12, a communicator 13, a location information determiner 14, and a camera 15.

The controller 11 is a calculation unit that realizes various functions of the in-vehicle apparatus 1 by executing a predetermined program. The controller 11 can be realized by, for example, a hardware processor such as a CPU. Furthermore, the controller 11 may be configured to include a RAM, a ROM (Read Only Memory), a cache memory, and the like.

In this embodiment, the controller 11 of the in-vehicle apparatus 1 is configured to have software modules such as an image capturing module 111, a notification module 112, and a provision module 113. Each software module may be realized by controller 11 (such as a CPU) executing a program stored in storage unit 12. The information processing executed by the software module is synonymous with the information processing executed by the controller 11 (CPU, etc.).

The image capturing module 111 photographs moving images (on-board videos) using the camera 15 while the in-vehicle apparatus 1 is in operation, and stores the captured on-board videos in the storage unit 12. In one example, the image capturing module 111 receives power supply from the vehicle 10 to capture images at all times, and records the obtained on-board videos in the storage unit 12.

The video data is made up of a plurality of video files. There is a limit to the length of the video that can be stored in one file, and if the limit is exceeded, a new video file is generated. In this embodiment, it is assumed that a video file is generated every minute. If the storage capacity is insufficient, the image capturing module 111 deletes the oldest video file to secure free and space then continues photographing. In this embodiment, each video file is associated with an identifier (date and time ID) for identifying the date and time when the video file was generated (i.e., the date and time when photographing started). In one example, the date and time ID may uniquely identify the year, month, day, hour, minute, and second. The image capturing module 111 operates as described above, so that the in-vehicle apparatus 1 functions as a drive recorder.

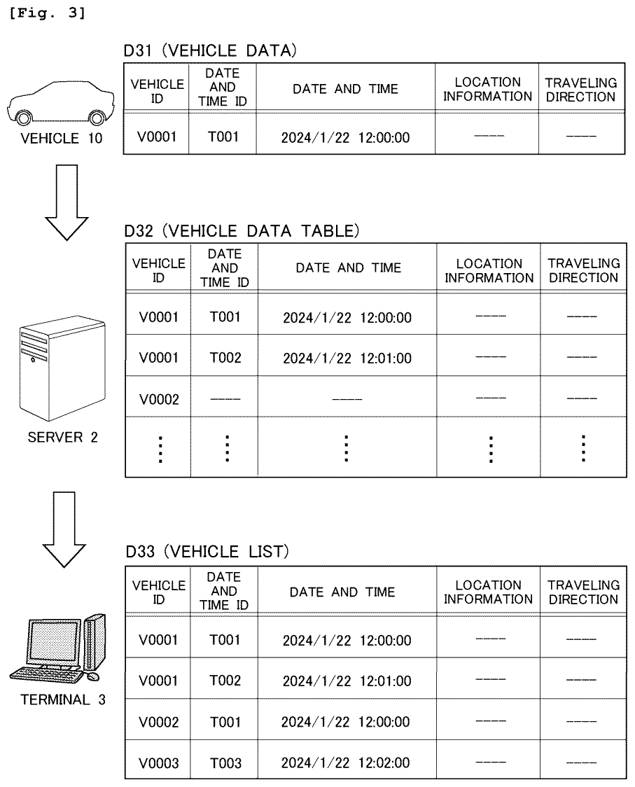

The notification module 112 periodically generates data related to the traveling of the vehicle (hereinafter, vehicle data), and transmits the vehicle data to the server 2. In this embodiment, the vehicle data includes location information of the vehicle 10, the traveling direction of the vehicle 10, and a date and time ID indicating the date and time when the location information was acquired. D31 in FIG. 3 is diagram illustrating an example of vehicle data. In this embodiment, the vehicle data includes an identifier (vehicle ID) that uniquely identifies the vehicle 10, the date and time when the vehicle data was generated, an identifier (date and time ID) that uniquely identifies the above date and time, location information of the vehicle 10, and information indicating the travelling direction of the vehicle 10. The location information and the traveling direction are acquired by the location information determiner 14 described later.

The vehicle data is generated and transmitted at a predetermined interval. The predetermined period may be measured independently, or may be linked to the image capturing module 111. In one example, the notification module 112 may generate vehicle data at a timing when the image capturing module 111 generates a new video file (e.g., in a one-minute cycle). In this case, the date and time indicated by the vehicle data will be the same as the date and time when the new video file was generated.

The provision module 113 provides the terminal 3 with a video file that was photographed at a specified time based on a request (a provision request of a video file) sent from the terminal 3. In one example, when the provision module 113 receives a provision request including a date and time ID from the terminal 3, the provision module 113 retrieves a video file corresponding to the date and time ID from the storage unit 22 and transmits the retrieved video file to the terminal 3.

The storage unit 12 stores information. In one example, the storage unit 12 may be configured with a storage medium such as a RAM, a magnetic disk, or a flash memory. The storage unit 12 stores the programs executed by the controller 11, data used by the programs, and the like.

The communicator 13 is a wireless communication interface for connecting the in-vehicle apparatus 1 to an external communication network. The communicator 13 is configured to be able to communicate with the server 2 via, for example, a wireless LAN or a cellular communication network (for example, 3G, 4G, or 5G).

The location information determiner 14 obtains location information of the vehicle 10. The location information determiner 14 includes a GPS antenna and a positioning module for positioning the location information. The GPS antenna receives positioning signals transmitted from positioning satellites (also called GNSS satellites). The positioning module calculates location information based on signals received by the GPS antenna. The location information determiner 14 may determine the traveling direction of the vehicle 10 based on the transition of the location information.

The camera 15 is an optical instrument that includes an image sensor for obtaining images. The camera 15 is mounted, for example, facing forward of the vehicle 10.

Next, the server 2 will be described. The server 2 can be, like the in-vehicle apparatus 1, configured as a computer having a processor (CPU, GPU, etc.), a main memory (RAM, ROM, etc.), and an auxiliary memory (EPROM, hard disk drive, removable media, etc.).

The server 2 includes a controller 21, a storage unit 22, and a communicator 23.

The controller 21 is a computing module that realizes various functions of the server 2 by executing a predetermined program. The controller 21 can be realized by, for example, a hardware processor such as a CPU. Furthermore, the controller 21 may be configured to include a RAM, a ROM (Read Only Memory), a cache memory, and the like.

In this embodiment, the controller 21 of the server 2 has software modules such as a data update module 211 and an information provision module 212. Each software module may be realized by the controller 11 (CPU, etc.) executing a program stored in the storage unit 22. The information processing executed by the software module is synonymous with the information processing executed by the controller 21 (CPU, etc.).

The data update module 211 receives vehicle data from a plurality of vehicles 10 (in-vehicle apparatuses 1) and stores the received vehicle data in the storage unit 22. In one example, the data update module 211 may store the vehicle data received from multiple vehicles 10 in a table (referred to as a vehicle data table) such as that illustrated D32 in FIG. 3.

The information provision module 212 provides information to terminal 3 based on the information stored in storage unit 22. Specifically, the information provision module 212 performs the following processes (1) and (2).

### (1) Providing Information Regarding Vehicle Location

The vehicle data table stores the location information of the vehicle 10 equipped with the in-vehicle apparatus 1 having a function as a drive recorder in association with date and time information. By referring to this, it is possible to extract vehicles 10 that have traveled within a specified area during a specified time period. When a request is received from the terminal 3, the information provision module 212 identifies vehicles 10 that have traveled within a specified area during a specified time period. The information provision module 212 transmits the location information and date and time information of the identified vehicle 10 to the terminal 3. This makes it possible for the terminal 3 to map the identified vehicle 10 on a map. The location information may include information indicating a travelling direction of the vehicle 10.

### (2) Relaying of On-Board Video

When a vehicle 10 for which an on-board video is to be requested is selected on the terminal 3, a play back request of the on-board video is transmitted from the terminal 3 to the server 2. The play back request of the on-board video includes information for identifying the target vehicle and the target date and time. Based on the above information, the information provision module 212 transfers the play back request of the on-board video to the target vehicle. In addition, the information provision module 212 transfers the video file (or video stream) of the on-board video transmitted from the target vehicle to the terminal 3.

The storage unit 22 stores information. The storage unit 22 is composed of a storage medium such as a RAM, a magnetic disk, or a flash memory. The storage unit 22 stores the programs executed by the controller 21, data used by the programs, and the like. The storage unit 22 also stores a table (vehicle data table) for storing data received from the in-vehicle apparatus 1.

The communicator 23 is a communication interface for connecting the server 2 to a communication network. The communicator 23 is configured to be able to communicate with a communication network, for example, via Ethernet (registered trademark), a wireless LAN, a cellular communication network, or the like.

Next, the terminal 3 will be described. The terminal 3 can be, like the in-vehicle apparatus 1, configured as a computer having a processor (CPU, GPU, etc.), a main memory (RAM, ROM, etc.), and an auxiliary memory (EPROM, hard disk drive, removable media, etc.).

The terminal 3 includes a controller 31, a storage unit 32, a communicator 33, and an input/output unit 34.

The controller 31 is a calculation unit that realizes various functions of the terminal 3 by executing a predetermined program. The controller 31 can be realized by, for example, a hardware processor such as a CPU. Furthermore, the controller 31 may be configured to include a RAM, a ROM (Read Only Memory), a cache memory, and the like.

In this embodiment, the controller 31 of the terminal 3 has software modules such as a display control module 311 and a video acquisition module 312. Each software module may be realized by the controller 11 (CPU, etc.) executing a program stored in the storage unit 32. The information processing executed by the software module is synonymous with the information processing executed by the controller 31 (CPU, etc.).

The display control module 311 generates a user interface (GUI) for requesting acquisition of on-board video. The display control module 311 outputs the generated GUI via the input/output unit 34, which will be described later. In this embodiment, the display control module 311 generates a user interface including a road map image based on road map data stored in the storage unit 32 or obtained in advance, and outputs the generated user interface. The above user interface includes a user interface component for specifying a target period.

In addition, the display control module 311 requests the server 2 to provide a vehicle list (a list of vehicles 10 that have been traveling within the display range of the map during the target period) based on the operation performed by the operator. Based on the response to the request, the display control module unit 311 maps icons representing the location of the vehicles 10 on the map. In one example, when the operator specifies the period “from 17:00 today to 17:03”, the display control module 311 requests the server 2 to “list of vehicles 10 that have been traveling within the displayed range of the map from 17:00 today to 17:03”. The display control module 311 performs icon mapping based on the received vehicle list.

When any one of the mapped icons is selected by the operator, the video acquisition module 312 transmits a play back request of the on-board video to the vehicle 10 corresponding to the selected icon. The video acquisition module 312 plays back a video file or a video stream of the on-board video received from the vehicle 10. In the following description, it is assumed that the play back request is transmitted to the vehicle 10 via the server 2 device 2. It is also assumed that the video file or video stream is received via the server 2.

The storage unit 32 stores information. The storage unit 32 is composed of a storage medium such as a RAM, a magnetic disk, or a flash memory. The storage unit 32 stores the programs executed by the controller 31, data used by the programs, and the like.

The communicator 33 is a wireless communication interface for connecting the terminal 3 to an external communication network. In one example, the communicator 33 is configured to be able to communicate with the server 2 via a wireless LAN or a cellular communication network (e.g., 3G, 4G, or 5G, etc.).

The input/output unit 34 receives input from the operator of the terminal 3 and presents information to the operator. Specifically, the input/output unit 34 is composed of a touch panel and its control component, and a liquid crystal display and its control component. In this embodiment, the touch panel and the liquid crystal display are configured as one touch panel display.

Note that, the configuration illustrated in FIG. 2 is merely an example, and all or part of the functions illustrated in FIG. 2 may be realized using a specially designed circuit. Furthermore, the programs may be stored and executed by a combination of a main memory and an auxiliary memory other than those illustrated in FIG. 2.

### Processing Details

Next, operations performed by the operator via the terminal 3 and processes executed as a result thereof will be described with specific examples.

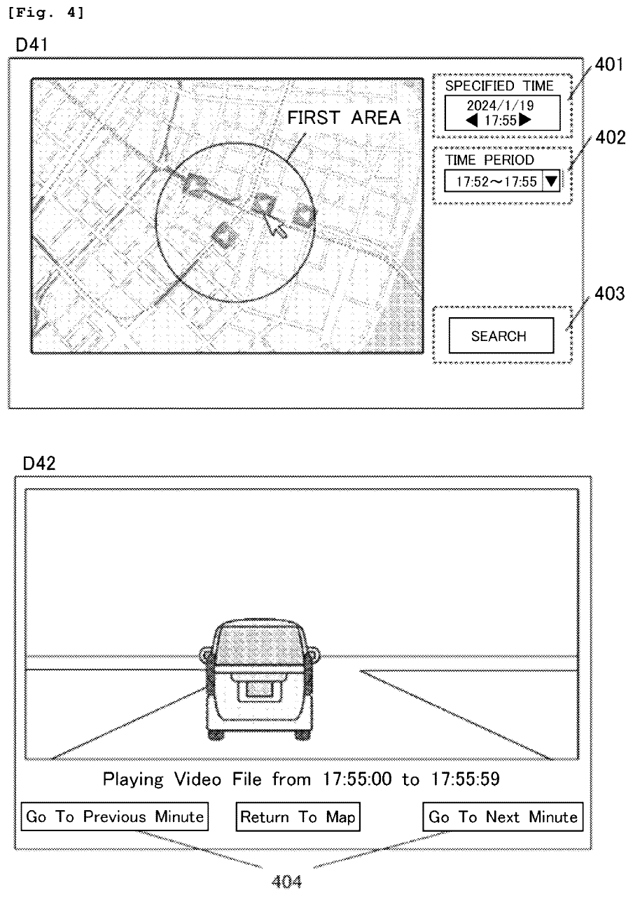

D41 in FIG. 4 is an example of a screen provided to the operator of the terminal 3. The display control module 311 of the terminal 3 generates a user interface including a road map centered on a predetermined point, and outputs the generated user interface to the input/output unit 34. The above user interface includes a component for specifying a time (reference numeral 401), a component for specifying a time range (reference numeral 402), and a button for executing a search (reference numeral 403).

Reference numeral 401 in FIG. 4 denotes a user interface component for specifying a time. The operator uses the user interface component to set, for example, the time when the emergency report was received. Reference numeral 402 in FIG. 4 denotes a user interface component for specifying a target period searching for vehicles. In one example, when the operator specifies “3 minutes ago”, the period to be searched is from “3 minutes before the set time to the set time”.

Furthermore, the display control module 311 sets an area (first area) on the map where the icon is to be superimposed and displayed. In this embodiment, the display control module 311 draws the map and at the same time sets the first area on the map. In one example, the first area may be within a circle having a predetermined size and centered on a midpoint of the map. In this case, the predetermined size may be determined by the size on the screen (pixels, etc.) or by the distance on the map (meters, etc.). The display control module 311 automatically resets (redraws) the first area when the operator moves the display area of the map or changes the scale.

When the operator presses the search button (numeral 403), data requesting a list of vehicles 10 that have traveled within the first area during the set period (for example, from 16:57 to 17:00) is transmitted from the terminal 3 to the server 2. The above request includes, for example, an information for identifying the first area, and an information indicating the target period, and the like.

In response to the request, the server 2 (information provision module 212) generates a list of applicable vehicles (vehicle list) and returns it to the terminal 3. D33 in FIG. 3 is an example of the returned vehicle list. Records included in the vehicle list referred to here may include the same vehicle. In one example, the same vehicle may transmit vehicle data multiple times within a set period within a first area. In this case, multiple records having the same vehicle ID will be included in the vehicle list.

The terminal 3 (display control module 311) that has received the vehicle list maps icons representing the vehicles at corresponding locations on the map. In this case, the icons may be arranged taking into consideration the travelling direction of the vehicle. An icon is generated for each record in the vehicle list. That is, the same vehicle may be represented by more than one icon. Note that, since the differences between the vehicles are not important to the operator, in this embodiment, information for identifying the vehicles is not displayed on the screen.

When the operator of the terminal 3 selects (e.g., clicks) any of the icons, on-board video is acquired from the vehicle 10 corresponding to that icon, and an operation for playing back the acquired on-board video is initiated.

In one example, when an icon is selected by an operator, the terminal 3 may immediately start acquiring on-board video from the vehicle 10. In another example, in response to an icon being selected by the operator, the terminal 3 may display the date and time corresponding to the selected icon (i.e., the date and time when the corresponding vehicle 10 was traveling through the target location). Then, when the operator checks the displayed date and time and inputs a new instruction to acquire on-board video into the terminal 3, the terminal 3 may start acquiring the on-board video.

Specifically, when an icon is clicked by the operator, the terminal 3 may overlay and display the date and time corresponding to the icon near the icon. The date and time corresponding to the selected icon may be obtained from the vehicle list received from the server 2. This allows the operator to grasp the time sequence even when there are multiple icons in the vicinity of a desired location (e.g., a report location). In addition, when the operator checks the date and time corresponding to the icon and clicks on the icon again, the terminal 3 may start playing back the on-board video.

When the operation for requesting playback of the on-board video is performed by the operator, a request for playing back the on-board video (hereinafter, a play back request) is transmitted from the terminal 3 to the server 2. The play back request includes a vehicle ID for specifying the vehicle 10 and a date and time ID for specifying the date and time. The server 2 that receives the play back request identifies the vehicle 10 that corresponds to the vehicle ID and transfers the play back request to the in-vehicle apparatus 1 of the identified vehicle 10.

The in-vehicle apparatus 1 that receives the play back request extracts the video file that corresponds to the specified date and time ID, and transmits the video file to the server 2. The video file in this case may be a video file of an on-board video or a video stream. The video file (or video stream) transmitted from the in-vehicle apparatus 1 to the server 2 is transferred from the server 2 to the terminal 3 and played back on the terminal 3.

D42 in FIG. 4 is an example of a playback screen on the terminal 3. In this example, since the video files are generated in one-minute units, playback is also in one-minute units. When an operator wishes to play back a video file before or after the video file currently being played back, the operator needs only press a button (reference numeral 404) for instructing movement forward or backward. In this case, a video file according to the operator's instruction is provided to the terminal 3 in the same manner as described above, and the provided video file is played back on the terminal 3. This allows the operator of the terminal 3 to play back the on-board video of the specified date and time.

### Processing Sequence

Next, the steps executed by each device included in the monitoring system and the flow of data exchanged between the devices will be described.

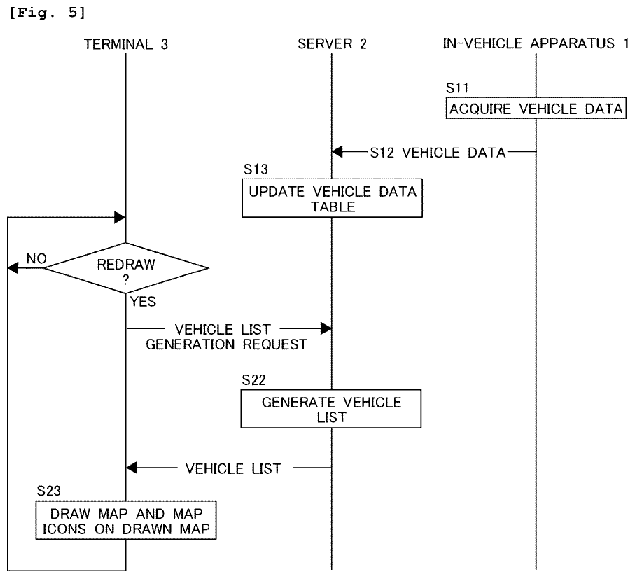

FIG. 5 is a sequence of the process of transmitting vehicle data from the in-vehicle apparatus 1 to the server 2, the process of transmitting information for mapping the location information of the vehicle 10 from the server 2 to the terminal 3, and the process of the terminal 3 drawing a map.

First, the process of transmitting vehicle data from the in-vehicle apparatus 1 to the server 2 (steps S11 to S13) will be described. The processes in steps S11 to S13 are repeatedly executed at a predetermined period. The predetermined period may be determined by the notification module 112 independently, or may be determined by the notification module 112 in response to a notification from the image capturing module 111. In one example, every time a video file is switched (for example, every minute), the image capturing module 111 may transmit a notification to the notification module 112. Then, in response to the notification, the notification module 112 may start the process of steps S11 to S13.

In step S11, the in-vehicle apparatus 1 (the notification module 112) obtains vehicle data. In detail, the notification module 112 obtains the location information of the vehicle 10 from the location information determiner 14. The notification module 112 generates vehicle data by combining the acquired location information and direction travelling with the identifier of the vehicle 10 and date and time information. The generated vehicle data is transmitted to the server 2 (step S12).

In step S13, the server 2 (the data update module 211) receives the vehicle data transmitted from the in-vehicle apparatus 3. The server apparatus 3 (the data update module 211) stores the received vehicle data in the vehicle data table in the storage unit 22.

By executing the processes of steps S11 to S13 for a plurality of vehicles 10, the server 2 can collect and manage past location information of the plurality of vehicles 10 under the management of the monitoring system. Moreover, by referring to the vehicle data table stored in the server 2, it becomes possible to search for a vehicle 10 that was traveling at a specified location on a specified date and time. Since each vehicle 10 has been travelling while photographing on-board video, it becomes easy to find a vehicle 10 that is likely to have captured a particular event (e.g., an accident, incident, or other event) through its on-board video.

Next, a process (steps S21 to S23) in which the terminal 3 outputs a road map onto which the vehicle location information is mapped will be described. In one example, the process of steps S21 to S23 is started in response to the display of a road map on the terminal 3 (display control module 311).

In step S21, the terminal 3 (display control module 311) determines whether or not it is necessary to redraw the icon. When the road map is displayed for the first time, when an operation to change the display range of the road map is performed, when an operation to change the target period is performed, etc., the determination in step S21 is positive. In one example, when an operation to display a road map is performed by the operator of the terminal 3 and a target period is specified, it becomes necessary to redraw the icon. If the determination in step S21 is positive, the terminal 3 generates a vehicle list generation request and transmits the generated generation request to the server 2. The generation request of the vehicle list includes information indicating the location of the first area set on the terminal device 3 and information indicating the target period specified by the operator.

In step S22, the server 2 (information provision module 212) generates a vehicle list based on the received generation request. Specifically, the server 2 extracts, from the vehicle data table stored in the storage unit 22, records of vehicles that have a track record of traveling within the first area during a specified period of time. The server 2 generates a vehicle list consisting of the extracted records. The generated vehicle list is transmitted from the server 2 to the terminal 3.

In step S23, the terminal 3 (display control module 311) draws a map on which the location of the vehicle 10 is mapped, based on the acquired vehicle list.

When the process of step S23 is completed, a screen on which a plurality of icons are mapped on map is displayed on terminal 3, as shown in D41 in FIG. 4. In this case, the multiple icons represent the respective locations of vehicles that have been traveling within the first area during the specified period.

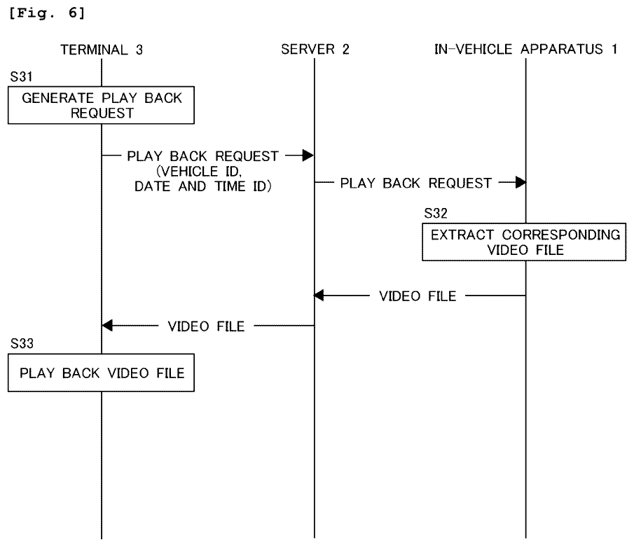

FIG. 6 is a sequence of the process in which the in-vehicle apparatus 1 provides on-board video to terminal 3 according to a request from terminal 3. The process in FIG. 6 is started in response to the operator specifying an icon on map in terminal 3.

As indicate FIG. 6, first, the terminal 3 (video acquisition module 312) generates a play back request (step S31). The play back request is data for requesting the in-vehicle apparatus 1 to provide the on-board video. Such the play back request includes an identifier (vehicle ID) of the in-vehicle apparatus 1 (vehicle 10) and an identifier (date and time ID) of the date and time when the on-board video was photographed. The vehicle ID and the date and time ID are included in the vehicle list that the terminal 3 receives from the server 2. When the operator selects an icon on the map, the terminal 3 can identify the vehicle ID and date and time ID of the corresponding vehicle 10.

The play back request is transmitted from the terminal 3 to the in-vehicle apparatus 1 via the server device 2. At this time, the server 2 needs to read the vehicle ID included in the play back request and identify the in-vehicle apparatus 1 to which the play back request is to be relayed. Therefore, the server 2 stores data that associates the vehicle ID with the connection destination (for example, a communication network address, etc.) of the in-vehicle apparatus 1.

The in-vehicle apparatus 1 (the provision module 113) that has received the play back request extracts the video file specified by the date and time ID from the stored video file data (step S32). The extracted video file is transmitted from in-vehicle apparatus 3 to terminal 3 via server 2. The terminal 3 generates a playback screen as illustrated in D42 in FIG. 4, and starts playing the received video file. Note that, if the operation is performed specify another video file (for example, if the button indicated by reference numeral 404 on the screen of D42 is pressed), the process shown in FIG. 6 is executed again and a new play back request is generated. Furthermore, the on-board video transmitted from the in-vehicle apparatus 1 to the terminal 3 is not limited to a video file, but may be a video stream or the like.

As described above, in monitoring system according to this embodiment, terminal 3 can map the vehicle's travelling history onto map based on the vehicle data stored in server 2. This allows the operator of terminal 3 to obtain the on-board video which was photographed by the specified vehicle 10, by specifying the vehicle 10 on the displayed map. As a result, the operator of the terminal 3 can check the on-board video which was photographed by the vehicle which travelled at a desired location at a desired time.

Furthermore, in this embodiment, the terminal 3 can set the first area on the map and can target only vehicles that have been traveling in the first area as mapping targets. This makes it possible to narrow down the area in which icons are displayed to a specific area even if there are a large number of vehicles which travelled within the display area of the map. As a result, the user experience is improved and computer resources are saved. Furthermore, by narrowing the range to which the icon is mapped, the above-mentioned privacy issues can be reduced.

In this embodiment, the first area is automatically set by the terminal 3, but the location and size of the first area may be changeable by the operator. For example, if the number of icons is too large in the default range, the size of the first area may be changed by the operator performing an operation such as changing a radius of 100 meters to a radius of 50 meters. At this time, the terminal 3 may set a limit so that the size of the first area does not become too large. For example, when the radius of the first area exceeds a predetermined value, or when the number of icons included in the first area exceeds a predetermined number, the terminal 3 may automatically limit the size of the first area.

### Modification

The above-described embodiment is merely an example, and the present disclosure can be modified and implemented as appropriate without departing from the scope of the present disclosure. For example, the processes and configurations described in this disclosure can be freely combined and implemented as long as no technical contradictions arise. In addition, in the embodiment, a vehicle equipped with an in-vehicle apparatus is exemplified, but a moving object other than a vehicle may be used as long as it is capable of photographing an image.

In the embodiment, the terminal 3 generates a user interface including the road map based on the information received from the server 2, but the server 2 may generate the user interface including the road map. In this case, instead of the server 2 generating the vehicle list and transmitting it to the terminal 3, the server 2 may draw the road map and map the icons. In this case, the server 2 may transmit the generated user interface including the road map to the terminal 3. Then, the terminal 3 outputs the user interface received from the server 2. That is, the functions of the terminal 3 (display control module 311) described in the embodiment may be provided in the server 2 (information provision module 212). Therefore, the information processing apparatus according to the present disclosure can be realized as a server 2 or as a terminal 3. When the server 2 draws the user interface screen, the server 2 outputs location information for arranging the icons on the map and time information corresponding to the icons. Note that the output here is not limited to outputting to an external device, but also includes passing information between elements of the server 2.

In the embodiment, a figure indicating the first area is drawn on the map, but such a figure does not necessarily have to be drawn on the map. Even if the first area is invisible, the same effect as in the embodiment can be obtained.

Note that, the processes described as being performed by one device may be shared and executed by a plurality of devices. Alternatively, the processes described as being performed by different devices may be performed by a single device. In a computer system, the hardware configuration by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a communication network. In one example, a non-transitory computer-readable storage medium may include any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random access memory (RAM), an EPROM, an EEPROM, a magnetic card, a flash memory, an optical card, or any type of medium suitable for storing electronic instructions.

What is claimed is:

1. An information processing apparatus comprising a controller configured to execute processing of:
displaying, within a first area set on a map, a plurality of icons indicating the locations of each vehicle at a plurality of times based on the travelling history of the one or more vehicles; and
transmitting, when any one of the plurality of icons is selected, to the corresponding vehicle a video request for requesting transmission of a video captured at the corresponding time.

2. The information processing apparatus according to the claim 1, wherein,
the controller does not draw icons corresponding to the one or more vehicles in any area other than the first area.

3. The information processing apparatus according to the claim 1, wherein,
when a point on the map is specified by an operator, the controller is configured to execute processing of:
setting the first area including the specified point; and
displaying icons corresponding to vehicles which have a history of traveling in the first area within the set first area.

4. An information processing method may be comprising following processing performed by a computer:
displaying, within a first area set on a map, a plurality of icons indicating the locations of each vehicle at a plurality of times based on the travelling history of the one or more vehicles; and
transmitting, when any one of the plurality of icons is selected, to the corresponding vehicle a video request for requesting transmission of a video captured at the corresponding time.

5. A non-transitory storage medium storing a program configured to cause a computer to execute processing of:
displaying, within a first area set on a map, a plurality of icons indicating the locations of each vehicle at a plurality of times based on the travelling history of the one or more vehicles; and
transmitting, when any one of the plurality of icons is selected, to the corresponding vehicle a video request for requesting transmission of a video captured at the corresponding time.
